(19) United States
(12) Patent Application Publication
(10) Pub. No.: US 2026/0292334 A1
(43) Pub. Date: Sep. 24, 2026

(54) IMAGE COLLECTION METHOD, APPARATUS, AND DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Weiming YANG, Shenzhen (CN); Shaoming WANG, Shenzhen (CN); Runzeng GUO, Shenzhen (CN); Jun WANG, Shenzhen (CN); Jinkun HOU, Shenzhen (CN)

(73) Assignee: TENCENT TECHNOLOGY (SHENZHEN) COMPANY LIMITED, Shenzhen (CN)

(21) Appl. No.: 19/687,459

(22) Filed: May 26, 2026

Related U.S. Application Data
(63) Continuation of application No. PCT/CN2024/122905, filed on Sep. 30, 2024.

(30) Foreign Application Priority Data
Jan. 30, 2024 (CN) 202410134106.4

(51) Int. Cl. H04N 23/661; H04N 23/73; H04N 23/74

(52) U.S. Cl. CPC H04N 23/662; H04N 23/73; H04N 23/74

(57) ABSTRACT

An image collection method, apparatus, and computer-readable storage medium for synchronized multi-camera capture with staggered exposure timing and coordinated lighting. The system includes master and slave cameras with connected frame synchronization interfaces configured for master output and slave input. The controller triggers periodic master camera exposure at configured frequencies. Upon completing each exposure, the master camera transmits frame synchronization signals to the slave camera, which performs staggered exposure upon receiving these signals. The controller manages light supplementation with timing that covers both cameras' exposure periods, where light supplement duration exceeds camera exposure durations and frame duration is an integer multiple of timing components. Both cameras transmit collected image data to the controller, enabling synchronized multi-camera imaging with temporal separation and optimal lighting coordination.

### CROSS-REFERENCE TO RELATED APPLICATIONS

This application is a continuation application of International Application No. PCT/CN2024/122905 filed on Sep. 30, 2024 which claims priority to Chinese Patent Application No. 202410134106.4, filed with the China National Intellectual Property Administration on Jan. 30, 2024, the disclosures of each being incorporated by reference herein in their entireties.

### FIELD

The disclosure relates to the technical field of image collection, an image collection method, apparatus, and device, a storage medium, and a program product.

### BACKGROUND

Nowadays, the modes of identity authentication are gradually increasing, including the modes of identity authentication through image collection and image feature comparison, such as palmprint recognition and face recognition.

In related art, in the process of image collection, generally, at least two cameras need to be simultaneously configured to collect identity authentication images respectively. Then, image features of the images collected by the at least two cameras are fused, thereby performing identity authentication using the fused image features.

However, in a collection solution for the identity authentication images provided in related art, the at least two cameras are independently controlled by a main control chip, and perform exposure at the same time under the control of the main control chip. As a result, instantaneous power consumption of an image collection device may be relatively high, which easily causes a problem of overheating of the device.

### SUMMARY

Provided are an image collection method and apparatus, a device, a storage medium, and a program product, which can implement synchronized multi-camera image capture with staggered exposure timing and coordinated lighting through master-slave camera control and precise timing-based light supplementation.

According to some embodiments, an image collection method, performed by an image collection device, the image collection device comprising a light supplement lamp, a master camera, a slave camera, and a controller, includes: transmitting, by the controller, a first exposure control signal to the master camera, wherein a frame synchronization interface of the master camera is connected to a frame synchronization interface of the slave camera, the frame synchronization interface of the master camera is configured to be in an output state, and the frame synchronization interface of the slave camera is configured to be in an input state; performing, by the master camera, periodic exposure at an exposure frequency configured by the controller, based on receiving the first exposure control signal; transmitting, by the master camera and the frame synchronization interface of the master camera, a frame synchronization signal to the slave camera based on completion of a single exposure; performing, by the slave camera, exposure based on receiving the frame synchronization signal by the frame synchronization interface of the slave camera, wherein an exposure time period of the slave camera is staggered from an exposure time period of the master camera; controlling, by the controller, the light supplement lamp to periodically supplement light, based on exposure moments of the master camera and the slave camera, wherein a light supplement time period of the light supplement lamp covers the exposure time period of the master camera and the exposure time period of the slave camera, the second timer duration being greater than or equal to single exposure durations of the master camera and the slave camera, and a frame duration being an integer multiple of a sum of the first timer duration and the second timer duration; and transmitting, by the master camera and the slave camera, collected image data to the controller.

According to some embodiments, an image collection apparatus, includes: a light supplement lamp; a master camera; a slave camera; at least one memory configured to store program code; and at least one controller configured to read the program code and operate as instructed by the program code, the program code including: transmission code configured to cause the at least one controller to transmit a first exposure control signal to the master camera, wherein a frame synchronization interface of the master camera is connected to a frame synchronization interface of the slave camera, the frame synchronization interface of the master camera is configured to be in an output state, and the frame synchronization interface of the slave camera is configured to be in an input state; master code configured to cause the master camera to perform periodic exposure at an exposure frequency configured by the controller, based on receiving the first exposure control signal; synchronization code configured to cause the master camera and the frame synchronization interface of the master camera to transmit a frame synchronization signal to the slave camera based on completion of a single exposure; slave code configured to cause the slave camera to perform exposure based on receiving the frame synchronization signal by the frame synchronization interface of the slave camera, wherein an exposure time period of the slave camera is staggered from an exposure time period of the master camera; light code configured to cause the at least one controller to control the light supplement lamp to periodically supplement light, based on exposure moments of the master camera and the slave camera, wherein a light supplement time period of the light supplement lamp covers the exposure time period of the master camera and the exposure time period of the slave camera; and data code configured to cause the master camera and the slave camera to transmit collected image data to the at least one controller.

According to some embodiments, a non-transitory computer-readable storage medium, storing computer code which, when executed by at least one controller, causes the at least one controller to at least: transmit a first exposure control signal to a master camera, wherein a frame synchronization interface of the master camera is connected to a frame synchronization interface of a slave camera, the frame synchronization interface of the master camera is configured to be in an output state, and the frame synchronization interface of the slave camera is configured to be in an input state; cause the master camera to perform periodic exposure at an exposure frequency configured by the controller, based on receiving the first exposure control signal; cause the master camera and the frame synchronization interface of the master camera to transmit a frame synchronization signal to the slave camera based on completion of a single exposure; cause the slave camera to perform exposure based on receiving the frame synchronization signal by the frame synchronization interface of the slave camera, wherein an exposure time period of the slave camera is staggered from an exposure time period of the master camera; control a light supplement lamp to periodically supplement light, based on exposure moments of the master camera and the slave camera, wherein a light supplement time period of the light supplement lamp covers the exposure time period of the master camera and the exposure time period of the slave camera; and cause the master camera and the slave camera to transmit collected image data to the at least one controller.

### DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of skill in the art may still derive other drawings from these accompanying drawings without creative efforts. In addition, one of skill would understand that aspects of some embodiments may be combined together or implemented alone.

FIG. 1 shows a schematic diagram of a main control chip independently controlling two cameras.

FIG. 2 shows a schematic diagram of a control process in a camera control solution.

FIG. 3 shows a schematic diagram of a control process in another camera control solution.

FIG. 4 shows a sequence diagram of exposure processes of two cameras.

FIG. 5 shows a sequence diagram of an exposure and light supplement process.

FIG. 6 shows a schematic diagram of a palmprint recognition device provided in some embodiments.

FIG. 7 shows a flowchart of an image collection method provided in some embodiments.

FIG. 8 shows a schematic diagram of an image collection device provided in some embodiments.

FIG. 9 shows a sequence diagram of camera exposure provided in some embodiments.

FIG. 10 shows a schematic diagram of an image collection device including two slave cameras provided in some embodiments.

FIG. 11 shows a schematic diagram of an image collection device including two slave cameras provided in some embodiments.

FIG. 12 shows a schematic diagram of a light supplement time period and an exposure time period provided in some embodiments.

FIG. 13 shows a sequence diagram of light supplement by a light supplement lamp and camera exposure provided in some embodiments.

FIG. 14 shows a sequence diagram of processes of light supplement by a light supplement lamp and camera exposure provided in some embodiments.

FIG. 15 shows a schematic structural diagram of an image collection device provided in some embodiments.

FIG. 16 shows a schematic structural diagram of a controller provided in some embodiments.

FIG. 17 shows a sequence diagram of a process of light supplement by a master light supplement lamp and a slave light supplement lamp provided in some embodiments.

FIG. 18 shows a schematic diagram of an image collection apparatus provided in some embodiments.

FIG. 19 shows a structural diagram of an image collection device provided in some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

During identity authentication, a user identity feature image, such as a fingerprint image, a face image, or a palmprint image, is often collected as a sample, and features of the collected image are extracted to obtain identity image features. In the process of identity authentication, image features collected and extracted in real time are compared with the identity image features stored in advance, to determine whether identity authentication is passed. Moreover, to ensure that the acquired image features are more comprehensive, a plurality of cameras may be configured at the same time to perform image collection, thereby obtaining the image features of different aspects or areas. For example, when face identity recognition is performed, infrared cameras can be configured to photograph infrared images for living body detection to ensure that an object on which the face recognition is performed is a living body. Moreover, a red-green-blue (RGB) camera is simultaneously configured to photograph an RGB image. Thus, face features are compared by using the RGB image, thereby achieving face identity recognition.

When a plurality of cameras are configured for image collection, the following two camera exposure control solutions are provided in related art.

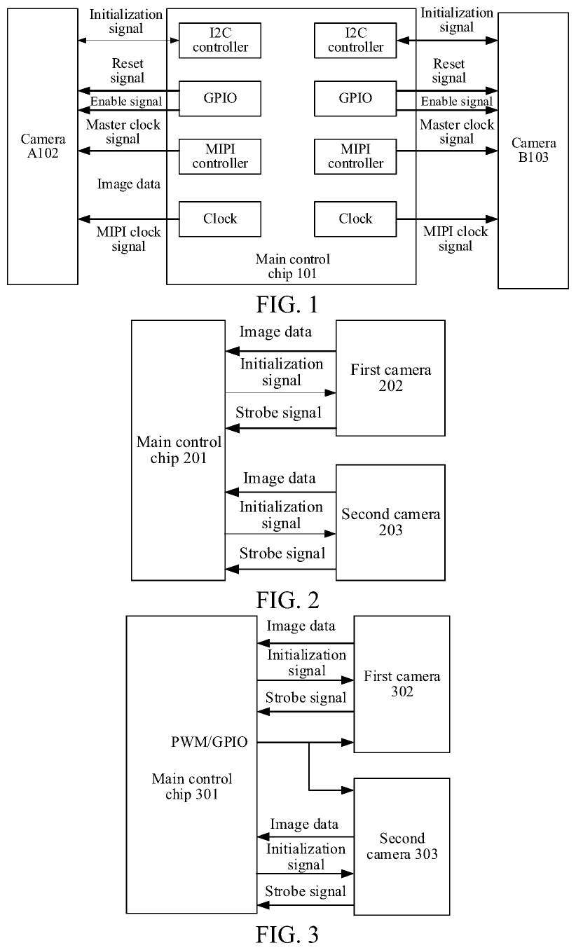

In a first related technical solution, an identity authentication device controls two cameras independently. Schematically, FIG. 1 shows a schematic diagram of a main control chip independently controlling two cameras. The figure includes a main control chip 101, a camera A102, and a camera B103. The main control chip 101 is respectively independently connected to, and independently controls the camera A102 and the camera B103.

The main control chip 101 includes an inter-integrated circuit (IIC) controller (or referred to as an I2C controller), configured to transmit, to the camera A102 or the camera B103, an initialization signal (an II2 signal), which may include a sequence signal, an exposure duration, and the like. The main control chip 101 is connected to the camera A102 and the camera B103 respectively through a general purpose input output (GPIO), and is configured to transmit a reset signal and an enable signal to the camera A102 and the camera B103. The main control chip 101 further includes a mobile industry processor interface (MIPI) controller, configured to transmit a master clock signal (mclk signal) to the camera A102 and the camera B103 respectively, and receive image data collected by the camera A102 and the camera B103. Moreover, the main control chip 101 further includes a clock, configured to transmit an MIPI clock signal to the camera A102 and the camera B103 respectively, where the master clock signal is an internal clock configured to drive the camera A102, the master clock signal determines an operating speed of the camera, and the MIPI clock signal refers to a clock signal of an MIPI interface, and is a clock signal configured to control synchronous transmission of the image data.

Schematically, FIG. 2 shows a schematic diagram of a camera control solution. The figure includes a main control chip 201, a first camera 202, and a second camera 203. The main control chip 201 controls the first camera 202 and the second camera 203 respectively, and is configured to transmit an initialization signal, a master clock signal, and the like to the first camera 202 and the second camera 203 respectively.

To improve image collection quality in a dark light environment, the first camera 202 and the second camera 203 transmit strobe signals to the main control chip 201, to instruct the main control chip 201 to control a light supplement lamp to supplement light. In the process of camera exposure, the strobe signals are in a high-level state. Correspondingly, the main control chip 210 controls the light supplement lamp to supplement light when the strobe signals are in the high-level state.

After a single exposure of the cameras, the first camera 202 and the second camera 203 transmit the collected image data to the main control chip 201. In the foregoing process, the cameras are in a continuous mode; the main control chip 201 independently controls the first camera 202 and the second camera 203; and various signals are transmitted to the first camera and the second camera respectively by a main control signal.

In a second related technical solution, the main control chip of the identity authentication device is connected to a camera A and a camera B respectively through a pulse width modulation (PWM) interface or a GPIO interface, and synchronously controls the camera A and the camera B through a frame synchronization (FSYNC) signal.

Schematically, FIG. 3 shows a schematic diagram of a camera control solution in this application. A main control chip 301 transmits initialization information and a master clock signal to a first camera 302 and a second camera 303. Moreover, the two cameras transmit strobe signals and image data to the main control chip. The main control chip 301 transmits a frame synchronization signal to the first camera 302 and the second camera 303 through a PWM interface or a GPIO interface respectively, thereby synchronously controlling the first camera 302 and the second camera 303. In the foregoing process, the cameras are in a master-slave mode, and an external host achieves synchronous control through PWM or GPIO.

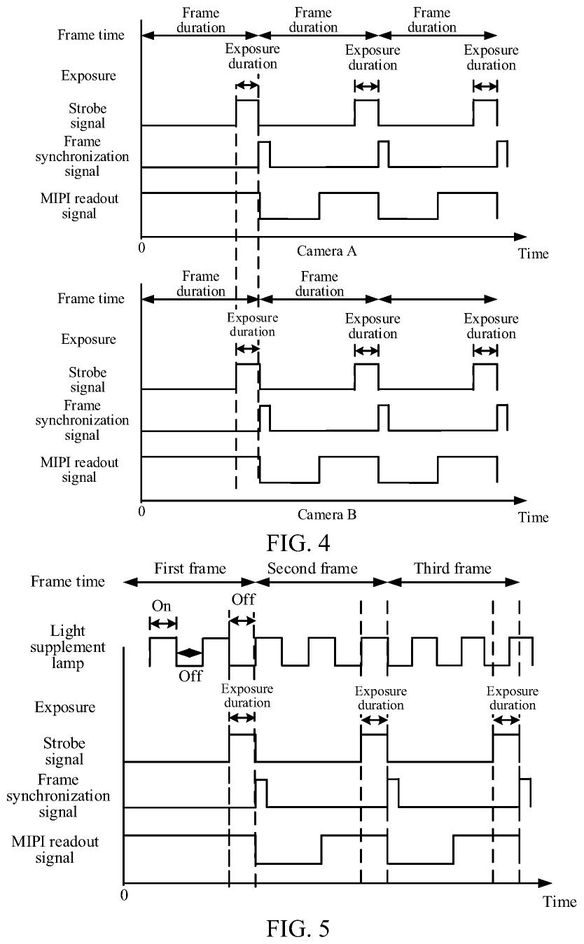

In the foregoing first related technical solution, the two cameras are independently controlled by the main control chip, so that continuous exposure can be achieved. FIG. 4 shows an exposure sequence diagram of the two cameras. An image sensor of the camera performs exposure at the end of a single frame. In the process of camera exposure, stroke signals are kept at a high-level state, and the image sensor emits the frame synchronization signal at a moment when the exposure ends.

In response to detection of a rising edge of the frame synchronization signal, the image sensor transmits, to the main control chip, image data collected in the single frame, and a corresponding MIPI readout signal is at a low level. After the transmission of the image data is completed, the MIPI readout signal changes to a high level state, i.e., the transmission of the image data is stopped. In the figure, exposure times of the camera A and the camera B overlap. Because the two cameras operate simultaneously, average current and peak power consumption are relatively high, i.e., overall power consumption is relatively large and a problem of overheating of the device easily occurs.

Table 1 shows a comparison of advantages and disadvantages of the foregoing first related technical solution and second related technical solution.

TABLE 1

| Solution | Exposure control | Advantages | Disadvantages |
|---|---|---|---|
| First related | Two cameras are | 1. Simple | 1. Relatively high |
| technical | independently | implementation | power consumption |
| solution | controlled for | 2. Suitability for | |
| | continuous | continuous | |
| | exposure | photographing | |
| Second | An external host | 1. Relatively | 1. Reliance on a high- |
| related | controls exposure | low peak power | precision clock |
| technical | through PWM or | consumption | 2. Relatively high |
| solution | GPIO | | complexity |
| | | | 3. Additional delay |

In the first related technical solution, the main control chip independently controls the two cameras respectively, which is relatively simple in implementations and suitable for continuous photographing. However, because the two cameras need to perform exposure simultaneously, the peak power consumption of the device is relatively high during simultaneous exposure.

In the second related technical solution, a time difference of exposure between the first camera and the second camera may be preset, to avoid generating relatively high power consumption caused by the simultaneous exposure of the two cameras. However, the main control chip controls the cameras to perform exposure through the frame synchronization signal (FSIN), and PWM driving and camera driving need to be synchronously achieved, thereby causing relatively high complexity. Moreover, performing synchronous control may rely on the high-precision clock to ensure that a time difference of the FSIN signals transmitted by the main control chip to the two cameras conforms to a set time difference. In addition, because system scheduling may be performed when camera exposure is controlled through PWM, a delay of system scheduling may also be generated in addition to the set time difference. Therefore, it cannot be ensured that the time difference of exposure between the two cameras conforms to the set time difference.

Therefore, to solve both problems existing in the foregoing first related technical solution and the foregoing second related technical solution, i.e., to achieve accurate synchronous control while reducing the peak power consumption, some embodiments provides an image collection method. Only a controller controls a master camera to perform exposure, and the frame synchronization signal emitted by the master camera controls a slave camera to perform exposure, so as to ensure that the exposure time of the master camera and the exposure time of the slave camera are staggered, thereby reducing the peak power consumption. Moreover, there is no need to rely on the high-precision clock, which can ensure the time difference of exposure between the master camera and the slave camera. Because the system scheduling is not needed, an additional delay is not generated.

In another aspect, because the quality of the image collected by the camera may affect the result of identity authentication, if a phenomenon of under-exposure appears during camera exposure, the quality of the image collected is relatively low. As a result, the result of identity authentication is inaccurate.

FIG. 5 shows a sequence diagram of exposure and light supplement. A high level of a light supplement lamp represents an on state, and a low level represents an off state. Moreover, a high level of a strobe signal represents that the camera performs exposure. In a first frame, an exposure time period of the camera corresponds to the off state of the light supplement lamp, resulting in invalid exposure of the camera. However, in a third frame, the light supplement lamp is first bright and then dim during the exposure time period, resulting in under-exposure. Correspondingly, the quality of the obtained image is poor.

Therefore, according to the solution provided in some embodiments, the light supplement time period can be aligned with the exposure time period, thereby avoiding problems of invalid exposure and under-exposure while minimizing power consumption.

The image collection method provided in some embodiments may be applied to at least the following scenarios.

### I. Palmprint Recognition Scenario.

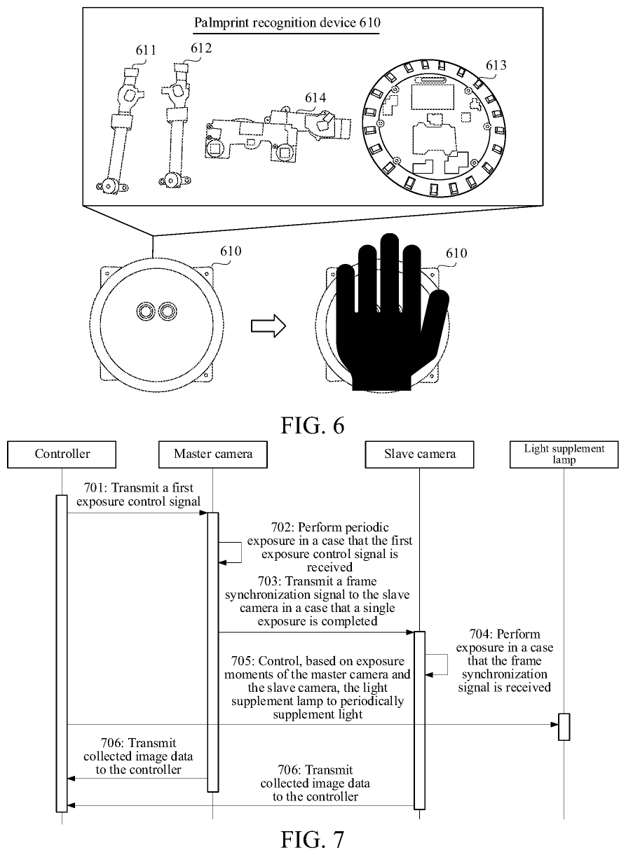

In a palmprint recognition scenario, a palmprint recognition device may be required to photograph a palmprint of a user. FIG. 6 shows a schematic diagram of a palmprint recognition device provided in some embodiments. In the figure, the palmprint recognition device 610 includes a first camera 611, a second camera 612, a light supplement lamp 613, an infrared emitting component 614 (such as an infrared LED), and a controller (not shown in the figure). The first camera 611 and the second camera 612 include an RGB camera and an infrared camera, and the first camera 611 serves as a master camera. The infrared emitting component 614 is configured to emit infrared light. An infrared ray emitted by the infrared emitting component 614 is reflected on a surface of an object, and the reflected infrared ray is received by the infrared camera, thereby obtaining infrared image data. In the process of palmprint recognition, patterns of palm veins can be acquired through the infrared camera as identity features, to perform palmprint recognition. The RGB camera is configured to collect an RGB image of a palm.

The infrared emitting component 614 emits infrared light invisible to human eyes. The infrared light is used as supplementary light in the exposure process of the infrared camera. Visible light emitted by the light supplement lamp 613 is used as supplementary light in the exposure process of the RGB camera.

In the process of palmprint recognition, a first exposure control signal is transmitted to the first camera 611 through the controller, to control the first camera 611 to perform periodic exposure. Moreover, after the first camera 611 completes a single exposure, the first camera 611 transmits a frame synchronization signal to the second camera 612, to control the second camera 612 to perform exposure. Moreover, during exposure time periods, the controller controls the light supplement lamp 613 to supplement light, and the first camera 611 and the second camera 612 transmit collected palmprint image data to the controller.

### II. Face Recognition Scenario.

In a face recognition scenario, a face recognition device may be required to collect a face image of a user. The face recognition device includes a controller and at least two cameras. In this embodiment, an example in which the face recognition device includes a first camera and a second camera is taken. The first camera is a master camera, and the second camera is a slave camera. In some embodiments, the first camera and the second camera may be an infrared camera and an RGB camera respectively, or may be RGB cameras configured to collect images of different face portions or images of face areas respectively.

Correspondingly, the face recognition device is further provided with a light supplement lamp. In some embodiments, the face recognition device may be provided with a plurality of light supplement lamps, and different light supplement lamps are configured to supplement light for exposure processes of different cameras. In a case that the type of cameras is the same, the different light supplement lamps may be of the same type. For example, the plurality of light supplement lamps are white light supplement lamps (visible light) for supplementing light for the RGB camera. In a case that the types of cameras are different, the different light supplement lamps may be of different types. For example, the light supplement lamps may include an infrared emitting component for supplementing light for an IR camera, and a white light supplement lamp for supplementing light for the RGB camera.

In the process of collecting face images, the controller in the face recognition device transmits a first exposure signal to the first camera, thereby controlling the first camera to perform periodic exposure; and the first camera transmits a frame synchronization signal to the second camera, thereby controlling the second camera to perform exposure. The controller controls, based on respective exposure time periods of the two cameras, the light supplement lamp to periodically supplement light, to avoid a phenomenon of under-exposure. Both the first camera and the second camera transmit collected face image data to the controller, so that the controller performs face feature comparison to obtain a face recognition result.

In addition, the solution provided in some embodiments may further be applied to other identity authentication scenarios, or a multi-camera image collection device in which image collection may be performed. In some embodiments, only the foregoing two application scenarios are taken as examples to describe modes of camera exposure control and light supplement lamp control in the image collection device.

Information (including but not limited to user palmprint information, user face images, and the like), data (including but not limited to data for analysis, data for storage, data for display, and the like), and signals involved in this application are all authorized by users or fully authorized by all parties, and collection, use, and processing of related data need to comply with related laws, regulations, and standards of related countries and regions.

Moreover, in this application, before and during acquisition of relevant data of a user, a prompt interface or a pop-up window may be displayed, or speech prompt information may be outputted. The prompt interface, the pop-up window, or the speech prompt information is configured for prompting the user that the relevant data of the user is currently being acquired. In this way, in this application, only after a confirmation operation performed by the user for the prompt interface or the pop-up window is acquired, relevant operations of acquiring the relevant data of the user start to be performed. Otherwise (in other words, when the confirmation operation performed by the user for the prompt interface or the pop-up window is not acquired), the relevant operations of acquiring the relevant data of the user are ended, i.e., the relevant data of the user is not acquired.

FIG. 7 shows a flowchart of an image collection method provided in some embodiments. The method is configured for the image collection device. The image collection device includes a light supplement lamp, a master camera, a slave camera, and a controller. The method includes the following operations.

Operation 701: The controller transmits a first exposure control signal to the master camera.

The first exposure control signal is a control signal that instructs the cameras to perform exposure. In some embodiments, in a case that a to-be-recognized object is recognized, the controller transmits the first exposure control signal to the master camera.

The master camera in some embodiments refers to a camera, which directly receives the exposure control signal transmitted by the controller, in a plurality of cameras. Moreover, the master camera can control, in the master-slave mode, the slave camera to perform exposure.

For example, when the image collection device includes an IR camera and an RGB camera, the IR camera is the master camera, and the RGB camera is the slave camera, or the RGB camera is the master camera, and the IR camera is the slave camera.

For another example, when the image collection device includes a first RGB camera and a second RGB camera, the first RGB camera is the master camera, and the second RGB camera is the slave camera, or the second RGB camera is the master camera, and the first RGB camera is the slave camera.

In some embodiments, before the first exposure control signal is transmitted to the master camera, the controller may further transmit an initialization signal, a reset signal, a master clock signal, and the like to the master camera, to ensure availability of an exposure function of the master camera.

In addition to controlling the cameras to perform exposure, a master controller can further control a light supplement lamp to supplement light, or process received image data returned by the cameras, or the like. For example, in a case that the image collection device is a palmprint recognition device, the controller transmits the first exposure control signal to the master camera to control the master camera to perform exposure. Moreover, after the master camera transmits collected palmprint images to the controller after exposure, the controller extracts palmprint features from the received palmprint images, thereby determining to-be-recognized palmprint features. The to-be-recognized palmprint features are compared with prestored palmprint features, thereby obtaining a palmprint recognition result.

In some embodiments, an end of a single exposure by the master camera is regarded as an end of a frame. Subsequently, the camera transmits image data collected in a previous frame to the controller.

In some embodiments, the master camera includes a master image sensor; the controller transmits the first exposure control signal to the master image sensor; and the master image sensor performs exposure in a case that the first exposure control signal is received.

Operation 702: The master camera performs periodic exposure in a case that the first exposure control signal is received.

The master camera performs periodic exposure according to a preset exposure frequency, and an exposure duration of each exposure of the master camera is also the same. Exposure refers to an amount of light shining on a camera sensor, and determines brightness of an image.

In an exemplary example, the master camera performs exposure at a frequency of 25 fps, and each exposure duration is 5 ms.

In some embodiments, the controller transmits the exposure duration and the exposure frequency to the master camera. In a subsequent process in which the controller controls the master camera to perform exposure, the exposure duration and the exposure frequency do not change.

In some embodiments, the controller transmits, in response to a modification operation of a user, an exposure duration and an exposure frequency that are modified to the master camera. Before the modification operation of the user is received again, the exposure duration and the exposure frequency do not change.

In some embodiments, while transmitting the first exposure signal to the master camera, the controller transmits the exposure frequency to the master camera. In a case that the exposure frequency and the first exposure signal are received, the master camera performs periodic exposure according to the received exposure frequency.

In some embodiments, a frame rate at which the master camera outputs images is related to a frequency at which the master camera performs exposure. The master camera can collect a frame of image each time the master camera performs exposure. Therefore, a higher exposure frequency of the camera indicates a larger frame rate at which the master camera outputs images.

Operation 703: The master camera transmits a frame synchronization signal to the slave camera in a case that a single exposure is completed.

Unlike related technologies where a controller transmits a frame synchronization signal to each camera to instruct each camera to perform exposure, in some embodiments, the master camera transmits a frame synchronization signal to the slave camera each time the master camera completes an exposure.

In some embodiments, the master camera and the slave camera are connected by a particular signal interface (pin). The particular signal pin is configured to perform frame synchronization signal transmission. Moreover, in an operating state, the master camera and the slave cameras are in the master-slave mode. In the master-slave mode, the slave camera receives, through the particular signal pin, the frame synchronization signal transmitted by the master camera, and performs exposure based on the frame synchronization signal transmitted by the master camera.

In a possible implementation, the frame synchronization signal is a high-level signal. To be specific, after the master camera completes a single round of exposure, a signal pin configured to perform frame synchronization signal transmission with the slave camera is set as a high-level signal.

Operation 704: The slave camera performs exposure in a case that the frame synchronization signal is received.

The slave camera performs exposure once in a case that the frame synchronization signal is received once.

Because the master camera transmits the frame synchronization signal to the slave camera in a case that a single exposure is completed, a frequency at which the slave camera receives the frame synchronization signal is consistent with the exposure frequency of the master camera. Further, the exposure frequency of the slave camera is consistent with the exposure frequency of the master camera. Therefore, a frame rate at which the slave camera collects images is consistent with that of the master camera.

For example, the exposure frequency of the master camera is 25 fps. In other words, the master camera collects 25 frames of images within one second. Thus, the master camera performs 25 exposures within one second. After each exposure, the master camera transmits the frame synchronization signal once to the slave camera. In other words, the master camera transmits the frame synchronization signal 25 times within one second. Thus, the slave camera also performs 25 exposures within one second. The frame rate is also 25 fps.

Performing exposure when the slave camera receives the frame synchronization signal transmitted by the master camera can enable the slave camera and the master camera to perform off-peak exposure, thereby avoiding heat generation of the image collection device caused by excessively high peak power consumption. Moreover, the controller can keep the time difference of exposure between the master camera and the slave camera stable without relying on the high-precision clock.

In a possible implementation, in a case that the frame synchronization signal is a high-level signal, the slave camera performs exposure when detecting the high-level signal through the particular signal pin.

Operation 705: The controller controls, based on exposure moments of the master camera and the slave camera, the light supplement lamp to periodically supplement light, a light supplement time period of the light supplement lamp covering exposure time periods of the master camera and the slave camera.

The light supplement time period of the light supplement lamp refers to a time period in which the light supplement lamp is in an on state. For example, for the infrared emitting component, the light supplement time period is a time period in which the infrared emitting component emits an infrared ray. For a visible light supplement lamp, the light supplement time period is a time period in which the visible light supplement lamp is lit.

The exposure time period refers to a time period in which the image sensor of the camera is in an exposure state.

In the exposure time period of the camera, the light supplement lamp may be in an on state, to supplement light for a to-be-photographed object. Therefore, the controller controls, based on the exposure moment of the camera, the light supplement lamp to periodically supplement light. A frequency at which the light supplement lamp performs exposure is the same as the exposure frequency of the camera.

Moreover, to avoid under-exposure of the camera caused by a case that the light supplement lamp is first bright and then dim or is first dim and then bright within the exposure time period, the light supplement time period of the light supplement lamp is to cover the exposure time period of the camera. The light supplement time period covering the exposure time period of the camera means that the exposure time period is within the light supplement time period, i.e., the length of the light supplement time period of the light supplement lamp is greater than or equal to the length of the exposure time period of the camera.

For example, if a light supplement duration of the light supplement lamp is 3 ms, and an exposure duration of the camera is 5 ms, even if the light supplement lamp starts to supplement light from a moment at which the camera starts to expose, the light supplement lamp is still in an off state within the last 2 ms of exposure of the camera, which may cause under-exposure. Therefore, the light supplement duration of the light supplement lamp is to be greater than the exposure duration of the camera. For example, the light supplement duration is 6 ms.

Operation 706: The master camera and the slave camera transmit collected image data to the controller.

After a single exposure of the master camera and the slave camera, the collection of an image frame is ended, thereby transmitting, to the controller, image data collected in a previous frame.

In some embodiments, after receiving the image data, the controller processes the image data to obtain image features to perform a subsequent operation. For example, in the face recognition device, the controller, based on the received image data, extracts face features to obtain to-be-recognized face features, and then compares the face features with prestored face features, thereby obtaining a face recognition result.

In conclusion, in some embodiments, the image collection device includes at least two cameras, including a master camera and a slave camera, and the master camera has a function of transmitting a frame synchronization signal to the slave camera. In the process of image collection, the controller only may transmit the exposure control signal to control the master camera to start periodic exposure. After completing the exposure each time, the master camera may transmit the frame synchronization signal to the slave camera, to instruct the slave camera to perform exposure. Thus, the master camera and the slave camera perform cross-exposure, thereby avoiding a problem of excessively high instantaneous power consumption caused by simultaneous exposure of the master camera and the slave camera. Moreover, after completing a single exposure, the master camera transmits the frame synchronization signal to the slave camera, so that the slave camera and the master camera can maintain the same frame rate to perform periodic exposure. In addition, the controller also controls the light supplement lamp to periodically supplement light, and ensures that the light supplement time period of the light supplement lamp covers the exposure time periods of the master camera and the slave camera, i.e., the light supplement lamp is kept in a turned-on state during the exposure time periods of the master camera and the slave camera, thereby avoiding a problem of under-exposure and improving image collection quality of the image collection device.

In some embodiments, the controller transmits the first exposure control signal only to the master camera, to control the master camera to perform exposure. The slave camera is controlled by the frame synchronization signal transmitted by the master camera. Therefore, a frame synchronization interface of the master camera is connected to a frame synchronization interface of the slave camera, the frame synchronization interface of the master camera is configured to be in an output state, and the frame synchronization interface of the slave camera is configured to be in an input state.

In some embodiments, in a case that the frame synchronization interface of the master camera is configured to be in the output state, the master camera can only transmit a signal externally through the interface and cannot receive a signal through the interface. In a case that the frame synchronization interface of the slave camera is configured to be in the input state, the camera can only receive a signal through the interface and cannot transmit a signal externally through the interface.

In a case that a single exposure is completed, the master camera transmits the frame synchronization signal to the slave camera through the frame synchronization interface. Correspondingly, the slave camera performs exposure in response to the frame synchronization signal received by the frame synchronization interface.

In some embodiments, a master-slave synchronization control relationship is formed between the master camera and the slave cameras, where the master camera controls the slave camera to perform exposure.

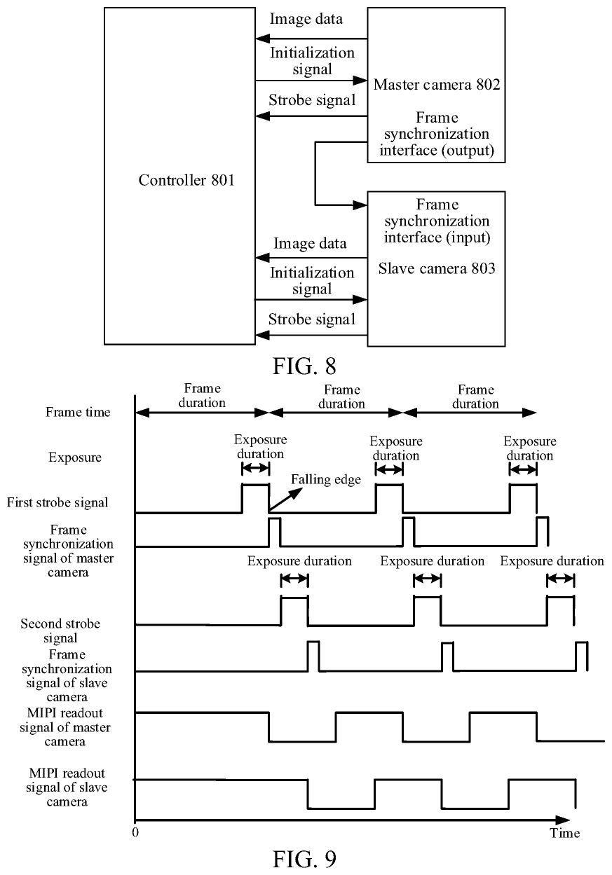

Schematically, FIG. 8 shows a schematic diagram of an image collection device provided in some embodiments. The image collection device includes a controller 801, a master camera 802, and a slave camera 803. The controller 801 transmits an initialization signal and a master clock signal to the master camera 802 and the slave camera 803 respectively. Moreover, with the exposure of the master camera 802 and the slave camera 803, the master camera 802 and the slave camera 803 transmit a strobe signal to the controller 801 respectively, to instruct the controller 801 to control a light supplement lamp to supplement light. After exposure, the master camera 802 and the slave camera 803 transmit collected image data to the controller 801 respectively.

The master camera 802 is connected to the slave camera 803 through frame synchronization interfaces (FSYNC). The frame synchronization interface of the master camera 802 is configured to be in an output state, and the frame synchronization interface of the slave camera 803 is configured to be in an input state. The controller 801 transmits a first exposure control signal to the master camera 802 through an IIC interface. Subsequently, the master camera 802 performs periodic exposure. Moreover, after completing a single round of exposure, the master camera 802 transmits a frame synchronization signal to the slave camera 803 through the frame synchronization interface, to control the slave camera 803 to perform exposure.

In the foregoing embodiment, a single master camera and a single slave camera are taken as an example for description. In some possible scenarios, when the image collection device is provided with n slave cameras (n≥2), a first slave camera to an (n−1)^{th} slave camera are configured with a plurality of frame synchronization interfaces, and an n^{th} slave camera is configured with one or more frame synchronization interfaces.

A first frame synchronization interface of the first slave camera is connected to the frame synchronization interface of the master camera, and a second frame synchronization interface of an i^{th} slave camera is connected to a first frame synchronization interface of an (i+1)^{th} slave camera, where i≥1, and i<n. Moreover, the first frame synchronization interface of each slave camera is configured to be in an input state, and the second frame synchronization interface of each slave camera is configured to be in an output state.

After completing a single exposure, the i^{th} slave camera transmits a frame synchronization signal to the first frame synchronization interface of the (i+1)^{th} slave camera through the second frame synchronization interface. After receiving the frame synchronization signal, the (i+1)^{th} slave camera performs exposure.

In this way, when the image collection device is provided with three or more cameras, exposure time periods of the cameras are staggered, to avoid peak power consumption caused by simultaneous exposure.

When the cameras perform exposure, the cameras may instruct, through strobe signals, the controller to supplement light. In a possible implementation, in the process of camera exposure, the strobe signals are in a high-level state. In a time period in which the cameras do not perform exposure, the strobe signals are in a low-level state. Therefore, in a case that the master camera completes a single exposure, the strobe signal is switched from a high level to a low level in a short time, to generate a signal falling edge. In some embodiments, in a case that the signal falling edge of the strobe signal is detected, the master camera transmits a frame synchronization signal to the slave camera through the frame synchronization interface.

The strobe signal may further be configured for instructing a light supplement lamp to supplement light. Moreover, because the strobe signal is switched to a low level at an end moment of exposure of the master camera, the signal falling edge corresponds to the end moment of exposure.

FIG. 9 shows a sequence diagram of camera exposure provided in some embodiments. An exposure sequence diagram of a master camera and an exposure sequence diagram of a slave camera are included.

In the exposure process of the master camera, a first strobe signal is in a high-level state. At an end moment of exposure, the first strobe signal is switched to a low level state, so that a signal falling edge of the first strobe signal is generated. In a case that the signal falling edge of the first strobe signal is detected, the master camera transmits a frame synchronization signal to the slave camera. In a case that the slave camera receives the frame synchronization signal, the slave camera starts to expose. During an exposure time period of the slave camera, a second strobe signal is in a high-level state.

When the exposure of the slave camera ends, the second strobe signal is switched to a low level state. Thus, in a case that a signal falling edge of the second strobe signal is detected, a frame synchronization signal corresponding to the slave camera is switched to a high level state. In addition, the master camera and the slave camera transmit, in response to a signal rising edge of the frame synchronization signal, collected image data to a controller. Correspondingly, an MIPI readout signal is switched to a low level state. After transmission of the image data ends, the MIPI readout signal is switched again to a high level state. In the figure, both the master camera and the slave camera transmit the collected image data to the controller after each exposure ends.

In a possible implementation, a plurality of cameras are present in the image collection device, and a master camera and at least two slave cameras are present in the plurality of cameras. There may be two connection modes for frame synchronization interfaces of the master camera and the slave cameras. The connection modes for the frame synchronization interfaces are described below by using an example in which three cameras are present in the image collection device.

Mode 1: The frame synchronization interfaces of the slave cameras are connected to the frame synchronization interface of the master camera.

The frame synchronization interface of the master camera is configured to be in an output state, and the frame synchronization interface of each slave camera is configured to be in an input state. In a case that the master camera completes a single exposure, the master camera transmits a frame synchronization signal to each slave camera through the frame synchronization interfaces, so that an exposure time period of the master camera can be staggered from an exposure time period of each slave camera, thereby reducing peak power consumption to a particular extent.

FIG. 10 shows a schematic diagram of an image collection device including two slave cameras provided in some embodiments. The image collection device includes a controller 1001, a master camera 1002, a first slave camera 1003, and a second slave camera 1004. The controller 1001 transmits an initialization signal, a master clock signal, and the like to a plurality of cameras respectively, and each camera transmits a strobe signal and collected image data to the controller 1101. When the cameras are controlled to perform exposure, the controller 1001 transmits a first exposure control signal to the master camera 1002, and transmits a frame synchronization signal to the first slave camera 1003 and the second slave camera 1004 respectively after the master camera 1002 completes a single exposure, to control the first slave camera 1003 and the second slave camera 1004 to perform exposure.

Mode 2: In a case that the slave cameras support serving as both a receiving end and a transmitting end of the frame synchronization signal, the frame synchronization interfaces of a plurality of slave cameras are sequentially connected.

In some embodiments, two frame synchronization interfaces are present in the first slave camera. One frame synchronization interface is configured to be in an input state and is connected to the master camera, and the other frame synchronization interface is configured to be in an output state and is connected to the second slave camera. In some embodiments, in a case that the master camera completes a single exposure, the master camera transmits a frame synchronization signal to the first slave camera through the frame synchronization interface, and the first slave camera performs exposure in a case that the frame synchronization signal is received. In a case that the first slave camera completes a single exposure, the first slave camera transmits the frame synchronization signal to the second slave camera through the frame synchronization interface, to control the second slave camera to perform exposure.

In this connection mode, the plurality of cameras can perform exposure successively, thereby avoiding heat generation of the device caused by excessively high peak power consumption.

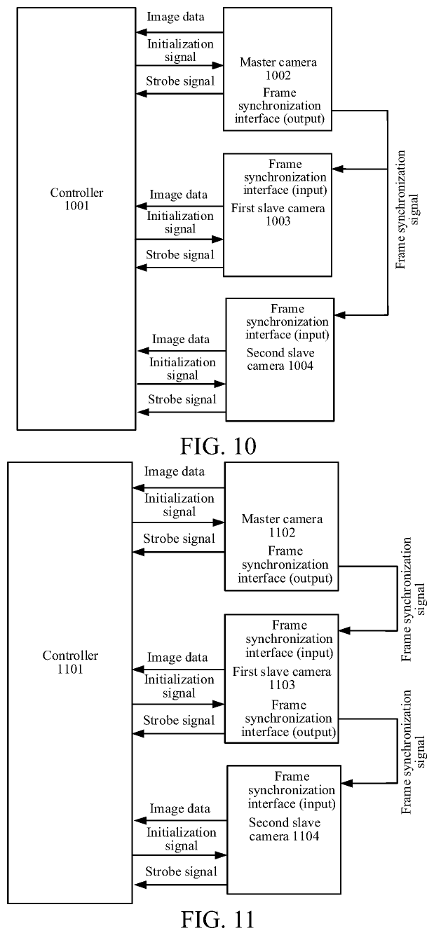

FIG. 11 shows a schematic diagram of an image collection device including two slave cameras provided in some embodiments. The image collection device includes a controller 1101, a master camera 1102, a first slave camera 1103, and a second slave camera 1104, where the controller 1101 transmits a first exposure control signal to the master camera 1102. After completing a single exposure, the master camera 1102 transmits a frame synchronization signal to the first slave camera 1103, to control the first slave camera 1103 to perform exposure. Moreover, in a case that the first slave camera 1103 completes a single exposure, the first slave camera 1103 transmits a frame synchronization signal to the second slave camera 1104, to control the second slave camera 1104 to perform exposure. In addition, the controller 1101 is connected to an IIC interface, a GPIO interface, and the like of each camera, to achieve transmission of other control signals and image data.

In some embodiments, the master camera transmits the frame synchronization signal to the slave cameras through frame synchronization interfaces, to control the slave cameras to perform exposure, so as to ensure that exposure frame rates of the slave cameras and the master camera are consistent and the cameras perform off-peak exposure to avoid relatively high peak power consumption.

Further, in a case that a plurality of slave cameras are arranged, two frame synchronization interfaces of the slave cameras are configured to be in an input state and an output state respectively. Thus, in a case that a current slave camera can complete a single round of exposure, a frame synchronization signal is transmitted to a next slave camera, to trigger the next slave camera to perform exposure, so that exposure time periods of the plurality of slave cameras are staggered to avoid the problem of peak power consumption caused by simultaneous exposure.

In a possible implementation, to avoid relatively large power consumption caused by continuous exposure of the cameras, the controller recognizes a to-be-photographed object within a photographing range, and controls the cameras to perform exposure in a case of recognizing that the to-be-photographed object is present.

The controller transmits a first exposure control signal to the master camera in a case of recognizing that the to-be-photographed object is present within the photographing range.

In a case of recognizing that the to-be-photographed object is present within the photographing range, it indicates that the image collection device currently may perform photographing. Therefore, the controller transmits the first exposure control signal to the master camera, and the master camera transmits the frame synchronization signal to the slave camera to control the slave camera to perform exposure.

For example, in a palmprint recognition scenario, the image collection device is a palmprint recognition device. Generally, the palmprint recognition device is to be fixed at a location for identity authentication. Therefore, in a case that no object that may be authenticated is present currently, it is expected that cameras in the palmprint recognition device do not perform exposure. Therefore, in a case of recognizing that a user or a palm is present within the photographing range, the controller transmits a first exposure control signal to the master camera. Thus, after the master camera completes a single exposure, the master camera transmits a frame synchronization signal to the slave camera to control the slave camera to perform exposure.

After the palmprint recognition device starts periodic exposure, the to-be-photographed object may leave the photographing range. Therefore, in a case of recognizing that the to-be-photographed object leaves the photographing range, the controller transmits a second exposure control signal to the master camera. The second exposure control signal is configured for controlling the master camera to stop periodic exposure. The master camera stops periodic exposure in a case that the second exposure control signal is received.

Because the master camera stops periodic exposure, the master camera does not transmit the frame synchronization signal to the slave camera. Therefore, the slave camera no longer performs exposure, which can avoid the waste of processing resources of the device due to much power consumption generated by exposure of the camera after the to-be-photographed object leaves the photographing range.

For example, in the palmprint recognition scenario, after the user performs palmprint recognition and the palm is away from the device by a particular distance, there is no need for continuous exposure. Therefore, after detecting that the palm leaves the photographing range, the controller transmits the second exposure control signal to the master camera, so that the master camera stops periodic exposure. Further, the slave camera stops exposure.

In some embodiments, an image photographing device includes a sensing detector. The sensing detector can emit an infrared signal or a microwave signal, so as to sense whether the to-be-photographed object is present within the photographing range. In addition, other modes can also be configured for recognizing whether the to-be-photographed object is present within the photographing range. In this embodiment, a mode of recognizing the to-be-photographed object within the photographing range is not limited.

In some embodiments, by recognizing whether the to-be-photographed object is present within the photographing range and determining whether the controller transmits the exposure control signal to the master camera, the camera can be prevented from performing periodic exposure when no to-be-photographed object is present within the current photographing range, thereby avoiding the waste of power consumption.

A strobe signal transmitted by the camera can represent whether the camera performs exposure currently. In some embodiments, in a case that the strobe signal is in a high-level state, the camera is in an exposure state; and in a case that the strobe signal is in a low-level state, the camera is in a non-exposure state. Therefore, the controller may control, according to a state of the received strobe signal, a light supplement lamp to supplement light, so that a light supplement stage of the light supplement lamp covers an exposure phase of each camera.

First, the controller receives strobe signals transmitted by the master camera and the slave camera. The strobe signals are configured for instructing light supplement.

The controller may detect four states of the strobe signals: a high level, a low level, a signal rising edge, and a signal falling edge. When the strobe signal is at a high level, the camera is in an exposure state, and in a case that the strobe signal is in a low-level state, the camera is in a non-exposure state. At a moment when the camera starts to expose, the strobe signal is switched from a low level to a high level, thereby generating a strobe signal rising edge. At a moment when the camera stops exposure, the strobe signal is switched from a high level to a low level, thereby generating a strobe signal falling edge.

In a possible implementation, the controller controls, based on the strobe signal states of the strobe signals, the light supplement lamp to periodically supplement light. The strobe signal states include the signal rising edge and the signal falling edge. The signal rising edge corresponds to an exposure start moment, and the signal falling edge corresponds to an exposure end moment.

In some embodiments, the controller controls the light supplement lamp to periodically supplement light when detecting target strobe signal states of the strobe signals. The target strobe signal states may be the signal rising edge and the signal falling edge.

Because the light supplement lamp may supplement light in an exposure time period, to avoid generating relatively high power consumption caused by continuous illumination of the light supplement lamp, the exposure start moment and the exposure end moment may be used as bases for controlling the light supplement lamp to be turned on and turned off, i.e., the signal rising edge and the signal falling edge of the strobe signals are used as the bases for controlling the light supplement lamp to be turned on and turned off.

In a possible implementation, for different strobe signal states, different control policies are configured in the controller. For example, when the strobe signal falling edge is detected, it indicates that exposure ends, and the controller may control the light supplement lamp to be turned off. However, when the strobe signal rising edge is detected, it indicates that exposure starts, and the controller may control the light supplement lamp to be turned on.

Therefore, the controller controls, based on a control policy corresponding to the target strobe signal states through a timer group, the light supplement lamp to periodically supplement light, so that a light supplement time period covers exposure periods.

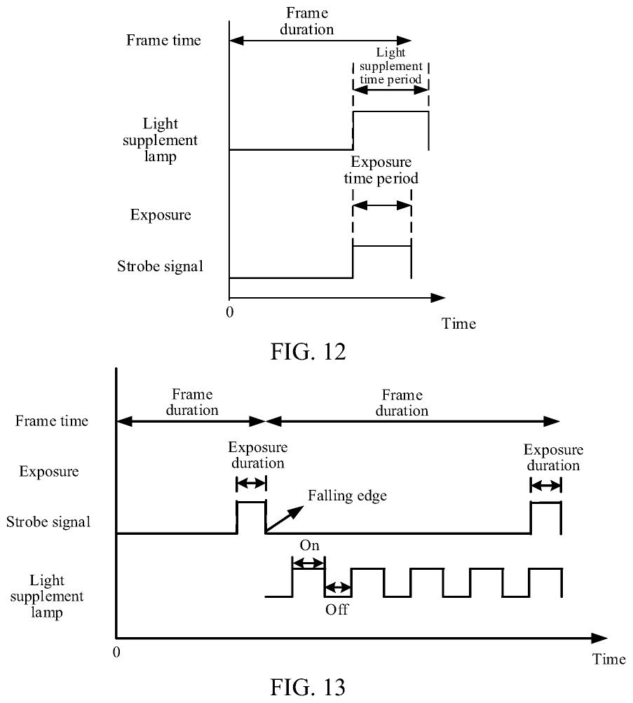

Schematically, FIG. 12 shows a schematic diagram of a light supplement time period and an exposure time period provided in some embodiments. In a case that a strobe signal is at a high level, a camera performs exposure. Thus, the light supplement time period (at a high level) of the light supplement lamp completely covers the exposure time period of the camera, which can ensure that the light supplement lamp is in an on state in the entire exposure time period.

The timer group includes a light-on timer and a light-off timer. The controller controls, according to timing states of different timers in the timer group, the light supplement lamp to periodically supplement light.

The light-on timer is configured to control a moment when the light supplement lamp starts to supplement light. In other words, when the light-on timer reaches a timer duration, the controller controls the light supplement lamp to be turned on. The light-off timer is configured to control a moment when the light supplement lamp stops supplementing light. In other words, when the light-off timer reaches a timer duration, the controller controls the light supplement lamp to be turned off.

In a possible implementation, when receiving strobe signals transmitted by different cameras, the controller controls, based on the same timer group, the light supplement lamp to periodically supplement light. The timer durations are set for the timers. After the timer is activated, the timer starts timing. In a case that a timing duration of the timer reaches the timer duration, the controller controls the light supplement lamp according to a control policy corresponding to the timer.

In a case that the light supplement lamp is controlled by the timer to periodically supplement light, the timing durations of the light-on timer and the light-off timer need to be set, so as to ensure that the light supplement lamp is in an on state within the exposure time period.

In some embodiments, the light-on timer corresponds to a first timer duration, and the light-off timer corresponds to a second timer duration. In a timing process of the light-off timer, if the light supplement lamp is in an on state, a duration for which the light supplement lamp is on may be greater than or equal to an exposure duration of the camera. Therefore, the second timer duration is to be greater than or equal to a single exposure duration of the camera.

In another aspect, because the light-on timer and the light-off timer perform timing alternately, in a case that it is ensured that a light-on duration is greater than the exposure duration, it further may ensure that a frame duration is an integer multiple of a sum of the first timer duration and the second timer duration, so as to ensure that a plurality of cameras can complete exposure in the same single frame duration.

For example, if a frame rate of a camera (a master or slave camera) is 25 fps, the frame duration is 40 ms. Assuming that the exposure duration is 5 ms, because the second timer duration is to be greater than or equal to a single exposure duration of the camera, the second timer duration may be set as 6 ms. Moreover, the frame duration may be an integer multiple of the sum of the first timer duration and the second timer duration, so the first timer duration may be 4 ms.

In some embodiments, there may be the following two cases when the controller controls, through the timer group, the light supplement lamp to periodically supplement light.

I. The light supplement lamp is controlled, based on a signal falling edge, to periodically supplement light.

In a possible implementation, in a case that the signal falling edge is detected, the controller activates the light-on timer in the timer group, and controls the light supplement lamp to be turned off. Subsequently, in a case that the light-on timer reaches a first timer duration, the controller activates the light-off timer in the timer group, and controls the light supplement lamp to be turned on. Moreover, in a case that the light-off timer reaches a second timer duration, the controller activates the light-on timer in the timer group, and controls the light supplement lamp to be turned off. Activating the timer refers to triggering the timer to start timing.

In a case that the signal falling edge is detected, it indicates that the exposure of the current camera ends. At this time, the light supplement lamp does not need to supplement light. In a case that the signal falling edge is detected, the light supplement lamp is controlled to be turned off. At the same time, the light-on timer in the timer group also may be activated. In the process that the light-on timer starts timing, the light supplement lamp is kept in an off state. In a case that the timing duration of the light-on timer reaches a preset first timer duration, the controller controls the light supplement lamp to be turned on, and activates the light-off timer. In a timing process of the light-off timer, the light supplement lamp is kept in an on state. Subsequently, if the timing duration of the light-off timer reaches a preset second timer duration, the light supplement lamp may be controlled to be turned off. Therefore, by alternately activating the light-on timer and the light-off timer in the timer group, the light supplement time period can cover the exposure time period of the camera.

In some embodiments, in a case that the signal falling edge is detected, the controller triggers an interrupt, and activates the timer group to start timing. The controller may configure the light-on timer and the light-off timer in advance. For example, the light-on timer and the light-off timer are set through a ktime_set( ) function, and the timers may be initialized through an hrtimer_init( ) function.

In some embodiments, in a case that the exposure duration of the camera and an image output frame rate are adjustable, the controller may dynamically configure the timer durations of the light-on timer and the light-off timer according to a real-time exposure duration of the camera and a real-time image output frame rate, to ensure that the timer duration of the light-off timer is greater than or equal to the real-time exposure duration, and the single frame duration (the reciprocal of the image output frame rate) is an integer multiple of the sum of the timer durations of the light-off timer and the light-on timer.

In some embodiments, in a case that the signal falling edge of a strobe signal is detected, the controller triggers an interrupt, and calls the preset light-on timer and the preset light-off timer in an interrupt function.

In a case that the signal falling edge is detected, the interrupt is triggered, and the interrupt function is executed. The controller first controls the light supplement lamp to be turned off, and activates the light-on timer for timing. In a case that the light-on timer reaches the first timer duration, the controller controls the light supplement lamp to be turned on, and simultaneously activates the light-off timer. In a case that the timing duration reaches the second timer duration, the light-off timer controls the light supplement lamp to be turned off, and activates the light-on timer for timing.

Schematically, FIG. 13 shows a sequence diagram of a light supplement process by a light supplement lamp and a camera exposure process provided in some embodiments. In the figure, in a case that a signal falling edge of a strobe signal is detected, a controller controls a light supplement lamp to be turned off, and activates a light-on timer in a timer group. The light-on timer starts timing after being activated. In a timing process, the light supplement lamp is in an off state (a low level). In a case that a first timer duration is reached, the controller controls the light supplement lamp to be turned on, and activates a light-off timer. In a timing process of the light-off timer, the light supplement lamp in the corresponding figure is in an on state (a high level). In a case of a second timer duration, the controller activates the light-on timer in the timer group and controls the light supplement lamp to be turned off. The light-on timer and the light-off timer perform timing alternately, to control periodic lighting of the light supplement lamp. In a case that the strobe signal is switched to a high level (i.e., a camera starts exposure), the light supplement lamp is kept in an on state until a strobe signal falling edge is detected again.

For example, when an image output frame rate of the camera is 25 fps (a frame duration is 40 ms), and an exposure duration is 4 ms, the first timer duration of the light-on timer is set as 4 ms, and the second timer duration of the light-off timer is set as 6 ms. In a case that the signal falling edge is detected, the controller activates the light-on timer in the timer group, and controls the light supplement lamp to be turned off. The light-on timer first performs timing. When the first timer duration is reached, the light supplement lamp is controlled to be turned on and the light-off timer is activated. A sum of the first timer duration and the second timer duration is 10 ms. The light-on timer and the light-off timer are activated four times respectively in one frame. An exposure time period is the last time period in one frame. Therefore, the light supplement lamp is controlled to be turned on when the light-off timer is activated for the last time, which can ensure that the light supplement lamp is in an on state within the exposure time period.

II. The light supplement lamp is controlled, based on a signal rising edge, to periodically supplement light.

In a possible implementation, in a case that the signal rising edge is detected, the controller activates the light-off timer in the timer group, and controls the light supplement lamp to be turned on. Subsequently, in a case that the light-off timer reaches a second timer duration, the controller activates the light-on timer in the timer group, and controls the light supplement lamp to be turned off. Similarly, in a case that the light-on timer reaches a first timer duration, the controller activates the light-off timer in the timer group, and controls the light supplement lamp to be turned on.

In a case that the signal rising edge is detected, it indicates that the current camera starts exposure. At this time, the light supplement lamp may supplement light. In a case that the signal rising edge is detected, the light supplement lamp is controlled to be turned on. At the same time, the light-off timer in the timer group also may be activated. In the process that the light-off timer starts timing, the light supplement lamp is kept in an on state. In a case that the timing duration of the light-off timer reaches a preset second timer duration, the controller controls the light supplement lamp to be turned off, and activates the light-on timer. In a timing process of the light-on timer, the light supplement lamp is kept in an off state. Subsequently, if the timing duration of the light-on timer reaches a preset first timer duration, the light supplement lamp may be controlled to be turned on. Therefore, by alternately activating the light-off timer and the light-on timer in the timer group, the light supplement lamp can be in an on state in a time period in which the camera performs exposure.

In some embodiments, in a case that the signal rising edge is detected, the controller triggers an interrupt, and activates the timer group to start timing. The controller may configure the light-on timer, the light-off timer, and an interrupt function in advance. A configuration process can refer to the configuration process shown in the foregoing embodiment, and will not be repeated in this embodiment.

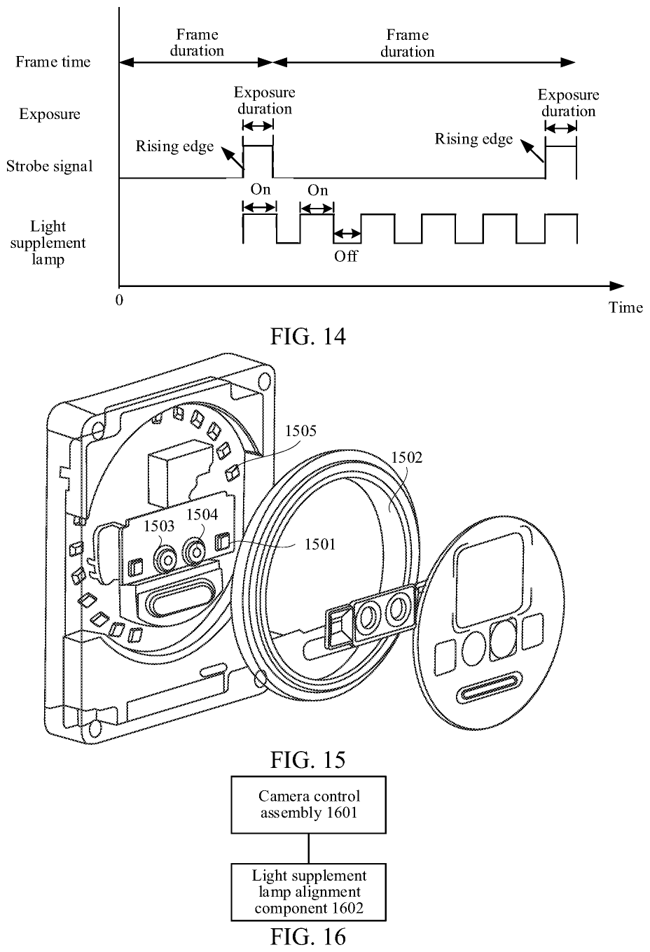

Schematically, FIG. 14 shows a sequence diagram of processes of light supplement by a light supplement lamp and camera exposure provided in some embodiments. In the figure, in a case that a signal rising edge of a strobe signal is detected, a controller controls a light supplement lamp to be turned on, and activates a light-off timer in a timer group. The light-off timer starts timing after being activated. In a timing process, the light supplement lamp is in an on state (a high level). In a case that a second timer duration is reached, the controller controls the light supplement lamp to be turned off, and activates a light-on timer. In a timing process of the light-on timer, the light supplement lamp in the corresponding figure is in an off state (a low level). In a case that a first timer duration is reached, the controller reactivates the light-off timer in the timer group and controls the light supplement lamp to be turned on. The light-on timer and the light-off timer perform timing alternately, to control periodic lighting of the light supplement lamp. In a case that the strobe signal is switched to a high level, the light supplement lamp is kept in an on state until a strobe signal rising edge is detected again.

For example, when an image output frame rate of the camera is 25 fps (a frame duration is 40 ms), and an exposure duration is 4 ms, the first timer duration of the light-on timer is set as 4 ms, and the second timer duration of the light-off timer is set as 6 ms. In a case that the signal rising edge is detected, the controller activates the light-off timer in the timer group, and controls the light supplement lamp to be turned on, so as to ensure that the light supplement lamp is in an on state within an exposure time period. The light-off timer first performs timing. When the second timer duration is reached, the light supplement lamp is controlled to be turned off and the light-on timer is activated. A sum of the first timer duration and the second timer duration is 10 ms. It is detected that the light-on timer and the light-off timer are activated for four times respectively between two adjacent signal rising edges. Moreover, when the signal rising edge is detected, the light supplement lamp is turned on, and the light-off timer is activated, which can ensure that the light supplement lamp is in an on state within the exposure time period.

In a possible implementation, the light-on timer and the light-off timer perform timing alternately. Because the controller performs factors such as function calling in a process of executing a control policy, after the light-on timer and the light-off timer perform timing alternately for a period of time, timing of the timers may not be accurate enough, and an offset between the light supplement time period and the exposure time period may be caused. Therefore, in a case that a signal falling edge and the signal rising edge are detected, the controller resets the light-on timer and the light-off timer, thereby avoiding a deviation between the light supplement time period and the exposure time period.

In some embodiments, before each activation of the light-on timer, the light-on timer is first reset. Moreover, before each activation of the light-off timer, the light-off timer is first reset. This can also ensure timing accuracy of the timers.

In a possible implementation, different light supplement lamps are present in the image collection device and are configured to supplement light within exposure time periods of different cameras respectively.

Schematically, FIG. 15 shows a schematic structural diagram of an image collection device provided in some embodiments. The image collection device includes an infrared light-emitting diode 1501, an RGB light guide ring 1502, an IR camera 1503, an RGB camera 1504, and a light supplement lamp 1505. The infrared light-emitting diode 1501 is configured to emit an infrared ray, so that the IR camera 1503 acquires infrared image data according to a reflection condition of the infrared ray, i.e., configured to supplement light for the IR camera 1503. The RGB light guide ring 1502 is configured to control the light reception of an image sensor when the RGB camera 1504 performs photographing. A plurality of light supplement lamps are included, and the light supplement lamp 1505 is configured to supplement light for the RGB camera 1504.

A master camera and a slave camera transmit strobe signals to a controller. The controller receives a first strobe signal transmitted by the master camera, or receives a second strobe signal transmitted by the slave camera.

Because different light supplement lamps are independently controlled, the controller controls, based on a strobe signal state of the first strobe signal, a master light supplement lamp corresponding to the master camera to periodically supplement light. The controller controls, based on a strobe signal state of the second strobe signal, a slave light supplement lamp corresponding to the slave camera to periodically supplement light, where the slave light supplement lamp is different from the master light supplement lamp.

The light supplement lamps corresponding to different cameras are controlled respectively by the controller based on respective corresponding strobe signals, which can satisfy respective exposure requirements of the two cameras.

Schematically, FIG. 16 shows a schematic structural diagram of a controller provided in some embodiments. The controller includes a camera control component 1601 and a light supplement lamp alignment component 1602. The camera control component 1601 is configured to control a master camera to perform periodic exposure. The light supplement lamp alignment component 1602 is configured to respectively control light supplement time periods of the light supplement lamps corresponding to a plurality of cameras to align with respective corresponding camera exposure time periods.

The following describes, based on signal falling edges of a first strobe signal and a second strobe signal, a process that the controller controls the light supplement lamps to periodically supplement light.

In the process of image collection, the controller transmits a first exposure control signal to the master camera, to control the master camera to perform periodic exposure. If the controller detects the falling edge of the first strobe signal at a moment at which the master camera completes a single exposure, the controller controls the light supplement lamp corresponding to the master camera to periodically supplement light. Moreover, in a case that the falling edge of the first strobe signal is detected, the master camera transmits a frame synchronization signal to a slave camera. In a case that the frame synchronization signal is received, the slave camera starts exposure. At an end moment of exposure of the slave camera, the controller can detect the falling edge of the second strobe signal, and then the controller controls a slave light supplement lamp corresponding to the slave camera to periodically supplement light.

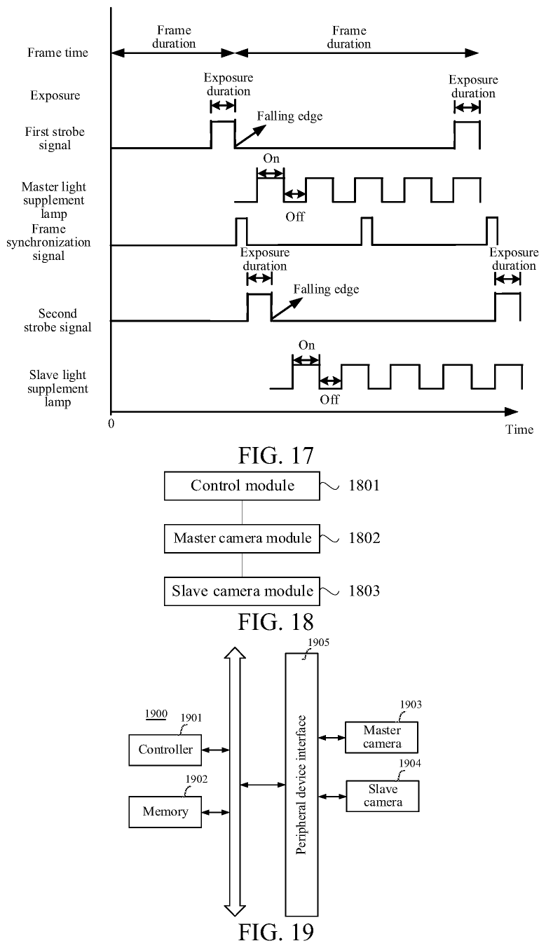

Schematically, FIG. 17 shows a sequence diagram of light supplement by a master light supplement lamp and a slave light supplement lamp provided in some embodiments. In a case that a signal falling edge of a first strobe signal corresponding to a master camera is detected, a controller controls the master light supplement lamp to periodically supplement light. In a case that a signal falling edge of a second strobe signal corresponding to a slave camera is detected, the controller controls the slave light supplement lamp to periodically supplement light. A light supplement time period of the master light supplement lamp is aligned with an exposure time period of the master camera, and a light supplement time period of the slave light supplement lamp is aligned with an exposure time period of the slave camera.

In some embodiments, the controller controls, according to a detected strobe signal state through a timer group, the light supplement lamps to periodically supplement light, which can ensure that light supplement times of the light supplement lamps are aligned with exposure times of the cameras by setting appropriate timing durations and control policies.

In addition, different cameras correspond to different light supplement lamps. The controller respectively controls the light supplement lamps to supplement light, so as to ensure that the exposure time of the master camera and the exposure time of the slave camera can be aligned with the light supplement times, to avoid the situation of under-exposure or invalid exposure.

In a possible implementation, in a case that a first exposure control signal is received, the master camera performs, based on an exposure frequency and a single exposure duration, periodic exposure. The exposure frequency is configured by the controller.

In some embodiments, when the controller transmits an initialization signal to the master camera, the controller synchronously transmits the exposure frequency to the master camera. Alternatively, before the controller transmits the first exposure control signal to the master camera each time, the controller first transmits the exposure frequency to the master camera.

In another possible implementation, when the image collection device collects an image of a to-be-photographed object, because the to-be-photographed object may stay in a photographing range of the camera for a relatively short time, the quality of the image photographed within the relatively short time may be poor. For example, the image is relatively blurry or the to-be-photographed object in the image is obscured, making it difficult to be used for subsequent processing. For example, in a palmprint recognition scenario, a user may not always keep a palm in a photographing area of the camera. Thus, poor quality of the image collected in a short time may lead to inaccurate palmprint recognition, leading to a low success rate of palmprint recognition.

In a possible implementation, the controller determines, based on historical image collection quality, at least one of an image output frame rate and an exposure duration of the camera, configures the cameras based on at least one of the image output frame rate and the exposure duration, and configures, according to at least one of the image output frame rate and the exposure duration, timer durations of a light-on timer and a light-off timer in the timer group.

To acquire more high-quality images in a relatively short time, in a case that the number of valid images in the images collected by the cameras is less than a number threshold, a photographing frame rate of the cameras may be increased, i.e., the exposure frequency of the cameras is increased. The valid images refer to images having image definition higher than a definition threshold. The exposure frequency of the cameras is increased so that the image collection device collects more images per unit time, so that the controller can select high-quality images from the collected more images for subsequent processing.

The adjusted exposure frequency of the cameras is transmitted to the cameras through the controller. After receiving the adjusted exposure frequency and receiving the first exposure control signal, the cameras configure the exposure frequency according to the adjusted exposure frequency, and perform periodic exposure.

For example, in a palmprint recognition scenario, if a relatively small number of valid images are collected in a palmprint recognition process, the photographing frame rate of the cameras is increased, i.e., the exposure frequency of the cameras is increased. Thus, in a palmprint recognition process, the image collection device can collect more palmprint images. Thus, the controller can select images with relatively high quality from these palmprint images, to further compare palmprint features. In a palmprint recognition scenario, valid images are images that can be configured to perform palmprint recognition, i.e., the palmprint features included in the valid images are relatively comprehensive.

In some embodiments, to acquire more high-quality images in a relatively short time, in a case that the number of valid images in the images collected by the cameras is less than a number threshold, a photographing exposure time of the cameras may be increased to shorten a duration for the cameras to acquire a single image frame, so that more images can be photographed per unit time.

Similarly, after the exposure frequency of the cameras is adjusted, to enable the light supplement lamp to supplement light in an exposure stage of the cameras, i.e., to cause a light supplement time period of the light supplement lamp to cover an exposure time period of the cameras, the controller may adjust, according to the adjusted frame rate and the exposure duration of the cameras, a first timer duration corresponding to the light-on timer and a second timer duration corresponding to the light-off timer.

In some embodiments, the frame rate of the cameras is configured by the controller. Moreover, in a case that the quality of a plurality of photographed images is poor, the controller can dynamically adjust the exposure frame rate and the exposure duration of the cameras, and specifically configure the timer group, to facilitate subsequent photographing of more images within the same duration, thereby acquiring images with higher quality.

FIG. 18 shows a schematic diagram of an image collection apparatus provided in some embodiments. The apparatus includes:
a control module 1801, configured to transmit a first exposure control signal to a master camera module 1802;
the master camera module 1802, configured to perform periodic exposure in a case that the first exposure control signal is received;
the master camera module 1802 being further configured to transmit a frame synchronization signal to a slave camera module 1803 in a case that a single exposure is completed; and
the slave camera module 1803, configured to perform exposure in a case that the frame synchronization signal is received;
the control module 1801 being further configured to control, based on exposure moments of the master camera module 1802 and the slave camera module 1803, a light supplement lamp to periodically supplement light, a light supplement time period of the light supplement lamp covering exposure time periods of the master camera module 1802 and the slave camera module 1803;
the master camera module 1802 being further configured to transmit collected image data to the control module 1801; and
the slave camera module 1803 being further configured to transmit collected image data to the control module 1801.

In some embodiments, the control module 1801 is configured to:
receive strobe signals transmitted by the master camera module 1802 and the slave camera module 1803, the strobe signals being configured for instructing light supplement, and light supplement moments instructed by the strobe signals matching the exposure moments; and
control, based on strobe signal states of the strobe signals, the light supplement lamp to periodically supplement light, the strobe signal states including a signal rising edge and a signal falling edge, the signal rising edge corresponding to an exposure start moment, and the signal falling edge corresponding to an exposure end moment.

In some embodiments, the control module 1801 is configured to:
control, based on a control policy corresponding to the strobe signal states through a timer group, the light supplement lamp to periodically supplement light, the timer group including a light-on timer and a light-off timer.

In some embodiments, the control module 1801 is configured to:
activate, in a case that the signal falling edge is detected, the light-on timer in the timer group, and control the light supplement lamp to be turned off;
activate, in a case that the light-on timer reaches a first timer duration, the light-off timer in the timer group, and control the light supplement lamp to be turned on; and
activate, in a case that the light-off timer reaches a second timer duration, the light-on timer in the timer group, and control the light supplement lamp to be turned off.

In some embodiments, the control module 1801 is configured to:
activate, in a case that the signal rising edge is detected, the light-off timer in the timer group, and control the light supplement lamp to be turned on;
activate, in a case that the light-off timer reaches a second timer duration, the light-on timer in the timer group, and control the light supplement lamp to be turned off; and
activate, in a case that the light-on timer reaches a first timer duration, the light-off timer in the timer group, and control the light supplement lamp to be turned on.

In some embodiments, the second timer duration is greater than or equal to single exposure durations of the master camera module 1802 and the slave camera module 1803, and a frame duration is an integer multiple of a sum of the first timer duration and the second timer duration.

In some embodiments, the control module 1801 is also configured to:
reset the light-on timer and the light-off timer in a case that the signal falling edge and the signal rising edge are detected.

In some embodiments, the control module 1801 is configured to:
receive a first strobe signal transmitted by the master camera module 1802, or receive a second strobe signal transmitted by the slave camera module 1803;
control, based on the strobe signal state of the first strobe signal, a master light supplement lamp corresponding to the master camera module 1802 to periodically supplement light; and
control, based on the strobe signal state of the second strobe signal, a slave light supplement lamp corresponding to the slave camera module 1803 to periodically supplement light, the slave light supplement lamp being different from the master light supplement lamp.

In some embodiments, a frame synchronization interface of the master camera module 1802 is connected to a frame synchronization interface of the slave camera module 1803, the frame synchronization interface of the master camera module 1802 is configured to be in an output state, and the frame synchronization interface of the slave camera module 1803 is configured to be in an input state.

The master camera module 1802 is configured to transmit the frame synchronization signal to the slave camera module 1803 through the frame synchronization interface in a case that a single exposure is completed.

In some embodiments, the master camera module 1802 is configured to:
transmit the frame synchronization signal to the slave camera module 1803 through the frame synchronization interface in a case that the signal falling edge of the strobe signal is detected, the strobe signal being configured for instructing light supplement, and the signal falling edge corresponding to the exposure end moment.

In some embodiments, the master camera module 1802 is configured to:
perform, based on an exposure frequency and single exposure durations, periodic exposure in a case that the first exposure control signal is received, the exposure frequency being configured by the control module 1801.

In some embodiments, the control module 1801 is configured to:
transmit the first exposure control signal to the master camera module 1802 in a case of recognizing that a to-be-photographed object is present within a photographing range; and
transmit a second exposure control signal to the master camera module 1802 in a case of recognizing that the to-be-photographed object leaves the photographing range.

The master camera module 1802 is configured to stop periodic exposure in a case that the second exposure control signal is received.

The apparatus provided in the foregoing embodiment is illustrated only with an example of division of the foregoing function modules. In practical applications, the foregoing functions may be allocated to and completed by different function modules based on requirements. That is, an internal structure of the apparatus is divided into different function modules to complete all or some of the functions described above. In addition, the apparatus and method embodiments provided in the foregoing embodiments belong to the same conception. For the implementation process, refer to the method embodiments. Details are not described herein again.

FIG. 19 shows a structural diagram of an image collection device 1900 provided in some embodiments. The image collection device may be a device having an image collection function, such as a palmprint recognition device or a face recognition device.

Generally, the image collection device 1900 includes a controller 1901 and a memory 1902.

The controller 1901 may include one or more processing cores, for example, a 4-core processor or an 8-core processor. The controller 1901 may be implemented by using at least one hardware form of a digital signal processing (DSP), a field-programmable gate array (FPGA), and a programmable logic array (PLA). The controller 1901 may further include a main processor and a coprocessor. The main processor is a processor configured to process data in an awake state, and is also referred to as a central processing unit (CPU). The coprocessor is a low power consumption processor configured to process the data in a standby state. In some embodiments, the controller 1901 may be integrated with a graphics processing unit (GPU). The GPU is configured to render and draw content that may be displayed on a display screen. In some embodiments, the controller 1901 may further include an artificial intelligence (AI) processor. The AI processor is configured to process computing operations correlated with machine learning.

The memory 1902 may include one or more computer-readable storage media. The computer-readable storage media may be tangible and non-transient. The memory 1902 may further include a high-speed random access memory and a non-volatile memory, for example, one or more disk storage devices or flash storage devices. In some embodiments, the non-transient computer-readable storage medium in the memory 1902 is configured to store at least one instruction. The at least one instruction is configured for being executed by the controller 1901 to implement the image collection method provided in the method embodiments of this application.

In some embodiments, a terminal 1900 may further include: a peripheral device interface 1905 and a peripheral device, where the peripheral device includes a master camera 1903 and a slave camera 1904.

The master camera 1903 and the slave camera 1904 are configured to photograph a to-be-photographed image within a photographing range and transmit collected image data to a controller. The master camera 1903 performs exposure based on an exposure control signal transmitted by the controller 1901, and the slave camera 1904 performs exposure based on a frame synchronization signal transmitted by the master camera 1903.

The peripheral device interface 1905 may be configured to connect at least one peripheral device related to input/output (I/O) to the controller 1901 and the memory 1902. In some embodiments, the controller 1901, the memory 1902, and the peripheral device interface 1905 are integrated on the same chip or circuit board. In some other embodiments, any one or two of the controller 1901, the memory 1902, and the peripheral device interface 1905 may be implemented on a separate chip or circuit board. This is not limited in this embodiment.

A person skilled in the art may understand that the structure shown in FIG. 19 constitutes no limitation on the terminal 1900, and the terminal 1900 may include more or fewer components than those shown in the figure, or a combination of some components, or have a different arrangement of components.

Some embodiments further provides a computer-readable storage medium, having at least one computer instruction stored therein, the at least one computer instruction being loaded and executed by a controller to implement the image collection method in the foregoing embodiments.

According to an aspect of this application, a computer program product is provided, including computer instructions, the computer instructions being stored in the computer-readable storage medium. The controller of the image collection device reads the computer instructions from the computer-readable storage medium and executes the computer instructions, to cause the terminal to execute the image collection method provided in various exemplary implementations in the foregoing aspects.

A person skilled in the art is to be aware that in the one or more examples, the functions described in some embodiments may be implemented by hardware, software, firmware, or any combination thereof. When implemented by the software, these functions may be stored in the computer-readable storage medium or transmitted as one or more instructions or codes on the computer-readable storage medium. The computer-readable storage medium includes a computer storage medium and a communication medium, where the communication medium includes any medium that facilitates transmission of computer programs from one location to another. The storage medium may be any available medium accessible to a general-purpose or dedicated computer.

The foregoing descriptions are merely exemplary embodiments of this application, but are not intended to limit this application. Any modification, equivalent replacement, or improvement made within the spirit and principle of this application is to fall within the protection scope of this application.

What is claimed is:

1. An image collection method, performed by an image collection device, the image collection device comprising a light supplement lamp, a master camera, a slave camera, and a controller, the method comprising:
transmitting, by the controller, a first exposure control signal to the master camera, wherein a frame synchronization interface of the master camera is connected to a frame synchronization interface of the slave camera, the frame synchronization interface of the master camera is configured to be in an output state, and the frame synchronization interface of the slave camera is configured to be in an input state;
performing, by the master camera, periodic exposure at an exposure frequency configured by the controller, based on receiving the first exposure control signal;
transmitting, by the master camera and the frame synchronization interface of the master camera, a frame synchronization signal to the slave camera based on completion of a single exposure;
performing, by the slave camera, exposure based on receiving the frame synchronization signal by the frame synchronization interface of the slave camera, wherein an exposure time period of the slave camera is staggered from an exposure time period of the master camera;
controlling, by the controller, the light supplement lamp to periodically supplement light, based on exposure moments of the master camera and the slave camera,
wherein a light supplement time period of the light supplement lamp covers the exposure time period of the master camera and the exposure time period of the slave camera, the second timer duration being greater than or equal to single exposure durations of the master camera and the slave camera, and a frame duration being an integer multiple of a sum of the first timer duration and the second timer duration; and
transmitting, by the master camera and the slave camera, collected image data to the controller.

2. The method according to claim 1, wherein the controlling the light supplement lamp comprises:
receiving, by the controller, a first strobe signal from the master camera and a second strobe signal from the slave camera, the first strobe signal and the second strobe signal indicating light supplement moments matching the exposure moments; and
controlling, by the controller, the light supplement lamp to periodically supplement light based on signal states of the first strobe signal and the second strobe signal, wherein the signal states comprise a signal rising edge corresponding to an exposure start moment and a signal falling edge corresponding to an exposure end moment.

3. The method according to claim 2, wherein the controlling the light supplement lamp based on the signal states comprises:
controlling, by the controller, the light supplement lamp to periodically supplement light via a timer group based on a control policy corresponding to the signal states, wherein the timer group comprises a light-on timer and a light-off timer.

4. The method according to claim 3, wherein the controlling the light supplement lamp via the timer group comprises:
based on detection of the signal falling edge, activating, by the controller, the light-on timer, and controlling the light supplement lamp to be turned off;
based on the light-on timer reaching the first timer duration, activating, by the controller, the light-off timer, and controlling the light supplement lamp to be turned on; and
based on the light-off timer reaching the second timer duration, activating, by the controller, the light-on timer, and controlling the light supplement lamp to be turned off.

5. The method according to claim 3, wherein the controlling the light supplement lamp via the timer group comprises:
based on detection of the signal rising edge, activating, by the controller, the light-off timer, and controlling the light supplement lamp to be turned on;
based on the light-off timer reaching the second timer duration, activating, by the controller, the light-on timer, and controlling the light supplement lamp to be turned off; and
based on the light-on timer reaching the first timer duration, activating, by the controller, the light-off timer, and controlling the light supplement lamp to be turned on.

6. The method according to claim 3, wherein the controlling further comprises: resetting, by the controller, the light-on timer and the light-off timer based on detection of the signal falling edge or the signal rising edge.

7. The method according to claim 6, further comprising:
resetting, by the controller, the light-on timer before each activation of the light-on timer; and resetting, by the controller, the light-off timer before each activation of the light-off timer.

8. The method according to claim 2, wherein:
the light supplement lamp comprises a master light supplement lamp corresponding to the master camera and a slave light supplement lamp corresponding to the slave camera, the slave light supplement lamp being different from the master light supplement lamp; and
the controlling the light supplement lamp based on the signal states comprises:
controlling, by the controller, the master light supplement lamp to periodically supplement light based on signal states of the first strobe signal; and
controlling, by the controller, the slave light supplement lamp to periodically supplement light based on signal states of the second strobe signal.

9. The method according to claim 1, wherein the master camera comprises a master image sensor; and
wherein the performing, by the master camera, periodic exposure comprises:
performing, by the master image sensor, the periodic exposure based on receiving the first exposure control signal.

10. The method according to claim 2, wherein the transmitting, by the master camera and the frame synchronization interface of the master camera, the frame synchronization signal to the slave camera comprises:
transmitting, by the master camera and the frame synchronization interface of the master camera, the frame synchronization signal to the slave camera based on detection of the signal falling edge of the first strobe signal.

11. The method according to claim 1, wherein the performing, by the master camera, periodic exposure based on receiving the first exposure control signal comprises:
performing, by the master camera, the periodic exposure at the exposure frequency and for a single exposure duration.

12. The method according to claim 1, wherein the transmitting, by the controller, the first exposure control signal to the master camera comprises:
transmitting, by the controller, the first exposure control signal to the master camera based on recognition that a to-be-photographed object is present within a photographing range;
the method further comprises:
transmitting, by the controller, a second exposure control signal to the master camera based on recognition that the to-be-photographed object leaves the photographing range; and
stopping, by the master camera, the periodic exposure based on receiving the second exposure control signal.

13. An image collection apparatus, comprising:
at least one memory configured to store program code; and
at least one processor configured to read the program code and operate as instructed by the program code, the program code comprising:
control code configured to cause at least one of the at least one processor to transmit a first exposure control signal to a master camera, wherein a frame synchronization interface of the master camera is connected to a frame synchronization interface of a slave camera, the frame synchronization interface of the master camera is configured to be in an output state, and the frame synchronization interface of the slave camera is configured to be in an input state;
exposure code configured to cause at least one of the at least one processor to perform, by the master camera, periodic exposure at an exposure frequency configured by a controller, in a case that the first exposure control signal is received;
synchronization code configured to cause at least one of the at least one processor to transmit, by the master camera and the frame synchronization interface of the master camera, a frame synchronization signal to the slave camera in a case that a single exposure is completed;
slave exposure code configured to cause at least one of the at least one processor to perform, by the slave camera, exposure in a case that the frame synchronization signal is received by the frame synchronization interface of the slave camera, wherein an exposure time period of the slave camera is staggered from an exposure time period of the master camera;
light code configured to cause at least one of the at least one processor to control a light supplement lamp to periodically supplement light, based on exposure moments of the master camera and the slave camera,
wherein a light supplement time period of the light supplement lamp covers the exposure time period of the master camera and the exposure time period of the slave camera; and
transmission code configured to cause at least one of the at least one processor to transmit, by the master camera and the slave camera, collected image data to the controller.

14. The apparatus according to claim 13, wherein the light code is further configured to cause at least one of the at least one processor to:
receive a first strobe signal from the master camera and a second strobe signal from the slave camera, the first strobe signal and the second strobe signal indicating light supplement moments matching the exposure moments; and
control the light supplement lamp to periodically supplement light based on signal states of the first strobe signal and the second strobe signal, wherein the signal states comprise a signal rising edge corresponding to an exposure start moment and a signal falling edge corresponding to an exposure end moment.

15. The apparatus according to claim 14, wherein the light code is further configured to cause at least one of the at least one processor to:
control the light supplement lamp to periodically supplement light via a timer group based on a control policy corresponding to the signal states, wherein the timer group comprises a light-on timer and a light-off timer.

16. The apparatus according to claim 15, wherein the light code is further configured to cause at least one of the at least one processor to:
in a case that the signal falling edge is detected, activate the light-on timer, and control the light supplement lamp to be turned off;
in a case that the light-on timer reaches a first timer duration, activate the light-off timer, and control the light supplement lamp to be turned on; and
in a case that the light-off timer reaches a second timer duration, activate the light-on timer, and control the light supplement lamp to be turned off.

17. The apparatus according to claim 15, wherein the light code is further configured to cause at least one of the at least one processor to:
in a case that the signal rising edge is detected, activate the light-off timer, and control the light supplement lamp to be turned on;
in a case that the light-off timer reaches a second timer duration, activate the light-on timer, and control the light supplement lamp to be turned off, and
in a case that the light-on timer reaches a first timer duration, activate the light-off timer, and control the light supplement lamp to be turned on.

18. The apparatus according to claim 15, wherein the light code is further configured to cause at least one of the at least one processor to:
reset the light-on timer and the light-off timer based on detection of the signal falling edge or the signal rising edge.

19. The apparatus according to claim 18, wherein the light code is further configured to cause at least one of the at least one processor to:
reset the light-on timer before each activation of the light-on timer; and
reset the light-off timer before each activation of the light-off timer.

20. A non-transitory computer-readable storage medium, storing computer code which, when executed by at least one processor, causes the at least one processor to at least:
transmit a first exposure control signal to a master camera, wherein a frame synchronization interface of the master camera is connected to a frame synchronization interface of a slave camera, the frame synchronization interface of the master camera is configured to be in an output state, and the frame synchronization interface of the slave camera is configured to be in an input state;
perform, by the master camera, periodic exposure at an exposure frequency configured by a controller, in a case that the first exposure control signal is received;
transmit, by the master camera and the frame synchronization interface of the master camera, a frame synchronization signal to the slave camera in a case that a single exposure is completed;
perform, by the slave camera, exposure in a case that the frame synchronization signal is received by the frame synchronization interface of the slave camera, wherein an exposure time period of the slave camera is staggered from an exposure time period of the master camera;
control a light supplement lamp to periodically supplement light, based on exposure moments of the master camera and the slave camera,
wherein a light supplement time period of the light supplement lamp covers the exposure time period of the master camera and the exposure time period of the slave camera; and
transmit, by the master camera and the slave camera, collected image data to the controller.
